(19) United States
(12) Patent Application Publication
(10) Pub. No.: US 2025/0193829 A1
(43) Pub. Date: Jun. 12, 2025

(54) METHODS FOR ENABLING A FIRST WIRELESS DEVICE TO DETERMINE A RELATIVE POSITION BETWEEN A PLURALITY OF SECOND WIRELESS DEVICES, A RELATED WIRELESS DEVICE AND RELATED NETWORK NODES

(71) Applicant: Sony Group Corporation, Tokyo (JP)

(72) Inventor: Lars NORD, Lund (SE)

(21) Appl. No.: 18/846,088

(22) PCT Filed: Mar. 17, 2023
(86) PCT No.: PCT/EP2023/056916

§ 371 Date: Sep. 11, 2024

(30) Foreign Application Priority Data
Mar. 29, 2022 (SE) 2250385-8

(51) Int. Cl. H04W 64/00; H04L 61/4511; H04W 12/06

(52) U.S. Cl. CPC H04W 64/00; H04L 61/4511; H04W 12/06

(57) ABSTRACT

A method is disclosed, performed by a service API controlling node, for enabling a first wireless device to determine a relative position between a plurality of second wireless devices based on a positioning function of a core network. The method comprises receiving, from the first wireless device, over an established data connection, an authorization request message for using a service API. The method comprises authorizing the first wireless device to use the service API for positioning of wireless devices. The method comprises receiving, from the first wireless device, using the service API for positioning of wireless devices, a message comprising information identifying the plurality of second wireless devices. The method comprises authorizing the first wireless device to determine the relative position of the plurality of second wireless devices. The method comprises performing, based on the positioning function and the message identifying the plurality of second wireless devices, a positioning procedure for determining the relative position of the plurality of second wireless devices.

The present disclosure pertains to the field of wireless communications. The present disclosure relates to methods for enabling a first wireless device to determine a relative position between a plurality of second wireless devices, a related wireless device and related network nodes, such as core network nodes.

### BACKGROUND

In the 3^{rd} Generation Partnership Project (3GPP) work is ongoing on positioning services, such as location-based services, of wireless devices. Positioning of wireless devices can be used to provide different services to a first wireless device when the first wireless device is at a certain location, such as in the vicinity of a second wireless device.

Typically, location-based services for wireless devices are based on interaction between the wireless device and a Location Management Function (LMF) using a Positioning protocol, such as an LTE Positioning Protocol (LPP) via control plane signaling. The first and the second wireless device may also use side-link positioning to determine whether they are in the vicinity of each other. Side-link positioning can also be used for determining a relative distance to between the first and the second wireless devices.

Some services may require a third wireless device, which may be out of range for side-link communication with the first and the second wireless devices, to know the relative position between the first and second wireless devices.

### SUMMARY

Accordingly, there is a need for devices and methods for enabling a wireless device to access a service Application Programming Interface (API) of a core network which may mitigate, alleviate or address the shortcomings existing and provides a wireless device access to the positions, such as the relative positions, of one or more other wireless devices, while reducing traffic on the control plane.

A method is disclosed, performed by a service Application Programming Interface, API, controlling node, for enabling a first wireless device to determine a relative position between a plurality of second wireless devices based on a positioning function of a core network. The method comprises receiving, from the first wireless device, over an established data connection, an authorization request message for using a service API. The authorization request message comprising access information authenticating the first wireless device to use the service API for positioning of wireless devices. The method comprises authorizing, using a data management function and based on the access information, the first wireless device to use the service API for positioning of wireless devices. The method comprises receiving, from the first wireless device, using the service API for positioning of wireless devices, a message comprising information identifying the plurality of second wireless devices, wherein the message requests a determination of the relative position of the plurality of second wireless devices. The method comprises authorizing, using a data management function and the message comprising information identifying the plurality of second wireless devices, the first wireless device to determine the relative position of the plurality of second wireless devices. The method comprises, upon the first wireless device being authorized to determine the relative position of the plurality of second wireless devices, performing, based on the positioning function and the message identifying the plurality of second wireless devices, a positioning procedure for determining the relative position of the plurality of second wireless devices. The method comprises sending, to the first wireless device, using the service API for positioning of wireless devices, the relative position of the plurality of second wireless devices.

Further, a service API controlling node comprising memory circuitry, processor circuitry, and an interface is provided. The service API controlling node is configured to perform any of the methods according to the current disclosure.

It is an advantage of the present disclosure that the service API controlling node can authenticate and establish, via the second interface, such as via an established data connection, a secure communication with the wireless device. Thereby, the wireless device can securely access the service API via the service API controlling node and may obtain positioning information of the one or more second wireless device via the service API over the data connection instead of via the control plane. This can reduce traffic and avoid congestion on the control channel. Further, providing access information required to access the service API to the wireless device, allows the wireless device to use the service API to access a position of one or more second wireless devices remotely, such as when the wireless device is not within side-link range of the one or more second wireless devices. Using the service API further allows the wireless device to access the position of the one or more second wireless devices remotely when the wireless device is located in a for example a different PLMN, such as in another country than the one or more second wireless devices. Furthermore, it is advantage that a network-controlled method can be provided allowing the wireless device to reuse a service API that is designed for application function use, instead of enhancing the signaling messaging over the control plane.

A method is disclosed, performed by a network node implementing a data management function, for enabling a first wireless device to determine a relative position between a plurality of second wireless devices. The method comprises receiving, from a service API controlling node, a validation request message to validate whether the first wireless device is authorized to use a service API for positioning of wireless devices. The validation request message comprises access information for accessing the service API for positioning of wireless devices.

The method comprises validating, based on the access information and one or more rules and/or subscription data, whether the wireless device is authorized to use the service API for positioning of wireless devices. The method comprises, upon the first wireless device being authorized to use the service API for positioning of wireless devices, transmitting, to the service API controlling node, an authorization validation accept message. The authorization validation accept message comprises dedicated information required to use the service API for positioning of wireless devices.

Further, a network node implementing a data management function comprising memory circuitry, processor circuitry, and an interface is provided. The network node implementing the data management function is configured to perform any of the methods according to the current disclosure.

It is an advantage of the present disclosure that the network node implementing a data management function can validate that the wireless device intending to access the service API is the wireless device it claims to be and that it is allowed to use the service API. Thereby, non-authorized wireless devices may be prevented from using the service API, which reduces traffic over the service API. Furthermore, it is advantage that a network-controlled method can be provided allowing the wireless device to reuse a service API that is designed for application function use, instead of enhancing the signaling messaging over the control plane.

A method is disclosed, performed by a first wireless device, for determining a relative position between a plurality of second wireless devices based on a positioning function of a core network. The method comprises sending, to a service API controlling node of a core network, over an established data connection, an authorization request message to use a service API for positioning of wireless devices. The authorization request message comprises access information for authenticating the first wireless device to use the service API for positioning of wireless devices. The method comprises, upon receiving an authorization accept message to use the service API for positioning of wireless devices, sending, to the service API controlling node using the service API for positioning of wireless devices, a message identifying the plurality of second wireless devices. The message triggers a determination of the relative position of the plurality of second wireless devices. The method comprises, upon the first wireless device being authorized by the service API controlling node to access the relative position of the plurality of second wireless devices, receiving, using the service API for positioning of wireless devices, the relative position of the plurality of second wireless devices.

Further, a wireless device comprising memory circuitry, processor circuitry, and a wireless interface is provided. The wireless device is configured to perform any of the methods according to the current disclosure relating to the first wireless device.

It is an advantage of the present disclosure that the first wireless device can obtain, using control plane signaling, access information required to access a service API via a data connection. By providing the control information via the control plane, the first wireless device may be authorized by the core network to use the service API and may receive the access information required to access the service API. This allows the wireless device to use the service API via a data connection for accessing a service, such as a positioning service, via the data connection instead of via the control plane. This can reduce traffic and avoid congestion on the control channel. Further, using the service API allows the wireless to access a position of one or more second wireless devices remotely, such as when the wireless device is not within side-link range of the one or more second wireless devices. Using the service API further allows the wireless device to access the position of the one or more second wireless devices remotely when the wireless device is located in a for example a different Public Land Mobile Network (PLMN), such as in another country than the one or more second wireless devices.

Furthermore, it is advantage that a network-controlled method can be provided allowing the wireless device to reuse a service API that is designed for application function use, instead of enhancing the signaling messaging over the control plane.

A method is disclosed, performed by a network node implementing a positioning function of a core network, for enabling a first wireless device to determine a relative position between a plurality of second wireless devices. The method comprises receiving, from a service API controlling node, a request for determining a relative position of the plurality of second wireless devices. The request comprises information identifying the plurality of second wireless devices. The method comprises performing a positioning procedure to determine the relative position between a plurality of second wireless devices. The method comprises sending, to the service API controlling node, a positioning result message comprising the relative position of the plurality of second wireless devices.

Further, a network node implementing a positioning function of a core network comprising memory circuitry, processor circuitry, and an interface is provided. The network node implementing the positioning function is configured to perform any of the methods according to the current disclosure.

It is an advantage of the present disclosure that the network node implementing a positioning function can be instructed to provide and can provide the measurement result to the first wireless device via the service API controlling node and the service API. This allows the wireless device to access the positioning service via the data connection instead of via the control plane. This can reduce traffic and avoid congestion on the control channel. Furthermore, it is advantage that a network-controlled method can be provided allowing the wireless device to reuse a service API that is designed for application function use, instead of enhancing the signaling messaging over the control plane.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 is a signaling diagram illustrating an example message exchange according to this disclosure for a first wireless device to register and get authorized to use a service API for positioning of a plurality of second wireless devices,

FIG. 3 is a flow-chart illustrating an example method, performed in a first wireless device, for accessing a service API and/or determining a relative position between a plurality of second wireless devices based on a positioning function of a core network according to this disclosure,

FIG. 4 is a flow-chart illustrating an example method, performed in a first core network node of a wireless communication system, for enabling a wireless device to access a service API of the core network according to this disclosure,

FIG. 5 is a flow-chart illustrating an example method, performed in a second core network node of a wireless communication system, for enabling a wireless device to access a service API of the core network according to this disclosure,

FIG. 6A-6B is a flow-chart illustrating an example method, performed in a third core network node of a wireless communication system, for enabling a wireless device to access a service API of the core network according to this disclosure,

FIG. 7 is a flow-chart illustrating an example method, performed in a fourth core network node of a wireless communication system, for enabling a wireless device to access a service API of the core network according to this disclosure,

FIG. 8 is a block diagram illustrating an example wireless device according to this disclosure,

FIG. 9 is a block diagram illustrating an example first core network node according to this disclosure,

FIG. 10 is a block diagram illustrating an example second core network node according to this disclosure,

FIG. 11 is a block diagram illustrating an example third core network node according to this disclosure, and

FIG. 12 is a block diagram illustrating an example fourth core network node according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

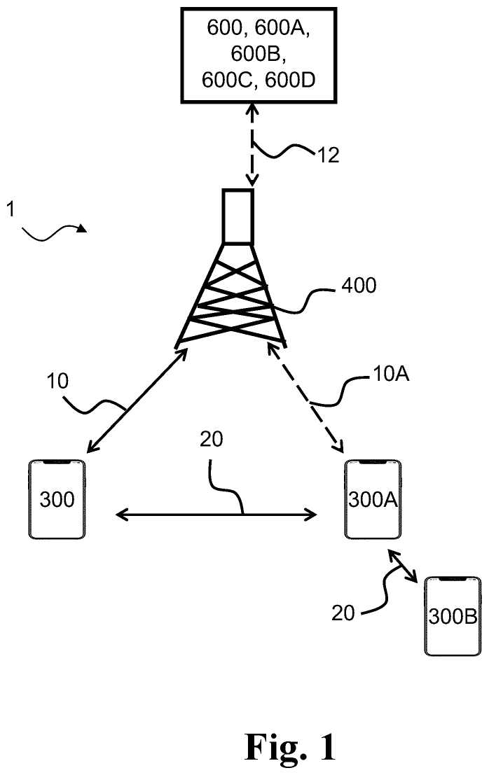

FIG. 1 is a diagram illustrating an example wireless communication system 1 comprising an example core network node 600, 600A, 600B, 600C, 600D, an example radio network node 400 an example first wireless device 300, and an example second wireless devices 300A and 300B according to this disclosure.

As discussed in detail herein, the present disclosure relates to a wireless communication system 1 comprising a cellular system, for example, a 3GPP wireless communication system.

The wireless communication system 1 comprises a wireless device 300 and/or a radio network node 400.

A radio network node disclosed herein refers to a radio access network node operating in the radio access network, such as a base station, an evolved Node B, eNB, gNB in NR. In one or more examples, the RAN node is a functional unit which may be distributed in several physical units.

A core network, CN, node disclosed herein refers to a network node operating in the core network, such as in the Evolved Packet Core Network, EPC, and/or a 5G Core Network, 5GC. Examples of CN nodes in EPC include a Mobility Management Entity, MME. The core network node may be configured to implement one or more functions, such as core network functions.

The functions may be one or more of an access and mobility management function 600A a data management function 600B, a Network Exposure Function (NEF) 600C, and a positioning function 600D. The functions are functional units which may be implemented in one or more physical units, such as in one or more physical core network nodes.

In one or more examples, the RAN node is a functional unit which may be distributed in several physical units.

The wireless communication system 1 described herein may comprise one or more wireless devices, such as a first wireless device 300 and one or more second wireless devices 300A/300B, and/or one or more network nodes 400, such as one or more of a base station, an eNB, a gNB and/or an access point.

A wireless device herein may refer to a mobile device and/or a user equipment, UE. The first wireless device 300 may be configured to communicate with the network node 400 via a first wireless link (or radio access link) 10. The second wireless device 300A may be configured to communicate with the network node 400 via a second wireless link (or radio access link) 10A.

The radio network node 400 may be configured to communicate with the CN node 600 via a wired or wireless link 12.

The wireless devices 300, 300A may be configured to communicate directly with each other via a side-link 20, such as without communicating via the radio network node 400. The side-link 20 may be a wireless link.

Typically, location-based services for a wireless device are based on interactions between the wireless device and a positioning function, such as an LMF, in the core network using a Positioning protocol, such as an LPP, via the control plane. A wireless device requiring a positioning estimate of another wireless device or a relative distance between two other wireless devices could use this protocol to request positioning estimates of the other wireless device or a relative distance between two other wireless devices. The procedure of estimating the relative distance between two wireless devices may herein be referred to as ranging.

However, using the LPP via the control plane would increase traffic over the control plane and could lead to the control plane being congested.

Instead of using the LPP via the control plane, the current disclosure provides a solution, in which the wireless device that requests relative positioning of two other wireless devices can use a service API, such as a northbound API, via the NEF, to access a function, such as a positioning function, of the core network. A northbound interface is an interface that allows the network function to communicate with a higher-level component, such as with an application function. The NEF allows service providers to handle data coming from application functions (AF) in a secure way with the right allocation and utilization of resources. The NEF API is traditionally only used by 3^{rd} party AFs or a Network Function (NF).

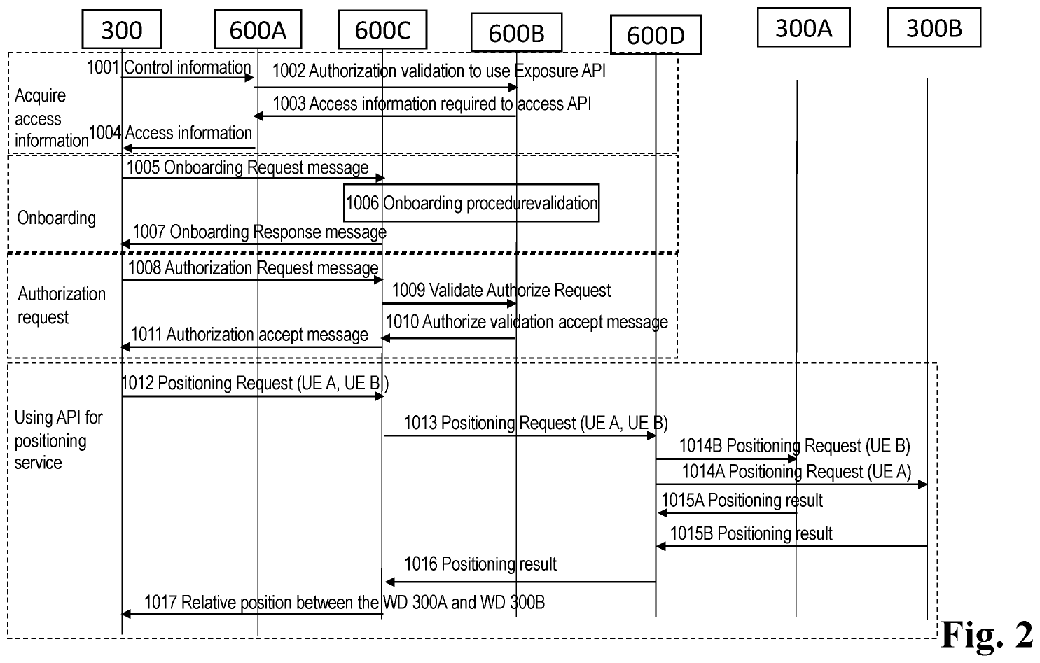

FIG. 2 is a signaling diagram illustrating an example message exchange 1000 between a first wireless device 300, a first core network node 600A, a second core network node 600B, a third core network node 600C, a fourth core network node 600D, a primary second wireless device 300A and a secondary second wireless device 300B, for enabling the first wireless device 300 to determine a relative position between a plurality of second wireless devices based on a positioning function of a core network according to one or more example methods disclosed herein. In one or more example methods herein, the first core network node 600A is a core network node implementing an access and mobility management function (AMF). In one or more example methods herein, the second core network node 600B is a core network node implementing one or more of an Authentication Server Function (AUSF), a Policy Control Function (PCF), a 5G Direct Discovery Name Management Function (DDNMF) and a Unified Data Management (UDM) function. In one or more example methods herein, the third core network node 600C is a core network node controlling the service API, such as a core network node implementing one or more of a Network Exposure Function (NEF) and a Common API Framework (CAPIF) function. In one or more example methods herein, the fourth core network node 600D is a core network node implementing a positioning function, such as a Location Management Function (LMF).

In one or more example methods disclosed herein, the first wireless device 300 acquires access information, such as a certificate (CERT), for using the service API. The wireless device 300, sends control information 1001, via a first interface, such as via a control plane, to the first core network node. The control information comprises one or more of an identifier identifying the wireless device and information identifying the service API that the wireless device intends to access. The first wireless device may in one or more example methods send a registration request message comprising the control information and may include an indication of a desire and/or intention to access the service API/Exposure API for positioning, such as for Ranging and Sidelink positioning. In one or more example methods, the indication of the desire and/or intention to access the service API can be signalled as a capability exchange, such as a UE capability exchange indicating that the first wireless device is capable of using the service API and/or a ranging or positioning service or can be a more explicit indication that the first wireless device would like to use the service API.

The first core network node 600A validates, based on the control information, that the first wireless device 300 is authorized to use the service API. The validation may be done by the first wireless device 600A sending authentication information 1002, such as the identifier identifying the wireless device, to the second core network node. The second core network node may validate, based on for example subscription information, that the first wireless device is authorized to use the service API, such as is authorized to use an exposure API to access the service API. Upon the second core network node validating that the first wireless device is authorized to use the service API, the second core network node provides, to the first core network node, access information 1003, such as Onboarding enrolment information and/or certificates, required to access the service API, such as access the service API controlling node, via a second interface, such as via an established data connection.

The first core network node 600A provides the access information 1004, such as the onboarding enrolment information and/or certificates to the first wireless device, such as in a registration accept message. The first wireless device 300 can use this access information to get authorized to use the service API.

In one or more example methods, the first wireless device 300, performs a service API onboarding procedure with the third core network node, such as with the service API controlling node, based on the onboarding information and/or the CERT received form the first core network node 300A, to set up a secure connection with the third core network node 600C via the second interface. In one or more example methods, the first wireless device 300 sends an onboarding request message 1005 to the third core network node 600C comprising the onboarding enrolment information and/or the CERT.

Based on the onboarding enrolment information and/or the CERT, the third core network node 600C performs an onboarding procedure for the first wireless device by validating 1006 the onboarding enrolment information and/or the CERT. Validating the onboarding enrolment information may comprise verifying enrolment credentials, such as an access token, of the first wireless device. Performing the onboarding procedure 1006 may further comprise generating a profile, such as an API invoker profile as specified in 3GPP TS 23.222 v. 17.5.0, for the first wireless device to use for accessing the service API.

The third core network node 600C provides an onboarding response message 1007 to the first wireless device comprising information from the generated profile for the wireless device.

In one or more example methods, the first wireless device 300 registers to get authorized to use the service API, such as a service API for positioning and/or ranging service, based on the enrolment information. The first wireless device 300 may send an authorization request message 1008 to the third core network node 600C. The authorization request message 1008 may for example comprise authentication information for authenticating the first wireless device 300, such as a Mobile Station International Subscriber Directory Number (MSISDN) and/or the provided CERT and/or information from the profile, such as the API invoker profile, provided in the onboarding response message. In one or more example methods, the authorization may be done in two steps, such as according to 3GPP TS 23.222 v.17.5.0, clause 8.10 and 8.11. The MSISDN may be used for identifying a subscription in a Global System for Mobile communications or a Universal Mobile Telecommunications System mobile network.

In one or more example methods, the third core network node 600C validates 1009 the authorization request with the second core network node 600B by sending the authentication information to the second core network node 600B. The validation may be based on the authentication information and one or more of a subscription information of the first wireless device 300 and a group belonging of the first wireless device 300.

Upon the second core network node 600B validating the authorization request, the second core network node 600B may send an authorization validation accept message 1010, such as an authorization confirmation message, to the third core network node. In one or more example methods, the authorization validation accept message 1010 may comprise dedicated information required to use the service API. The dedicated information may comprise a key and/or a secret generated by the second core network node.

In one or more example methods, the third core network node 600C transmits, using the service API for positioning of wireless devices, an authorization accept message 1011 indicating that the first wireless device has been accepted to use the service API for positioning of wireless devices. The authorization accept message may comprise the dedicated information required to use the service API.

Once authorized to use the service API, such as the service API for positioning of wireless devices, the first wireless device 300 may send a message 1012 requesting a positioning of a plurality of second devices, such as a positioning request, such as a relative positioning and/or ranging request, via the service API. The message 1012 may comprise an identifier for identifying the plurality of second wireless devices. The message 1012 may trigger a further authorization validation to verify that the first wireless device is authorized to retrieve the requested positioning information. The message 1012 may trigger a ranging and/or relative positioning between two second wireless devices (such as between wireless device 300A and wireless device 300B).

The third core network node may trigger the fourth core network node 600D, such as the LMF, to send a positioning request 1014A, 1014B, such as a relative positioning request to one or both of the second wireless devices (such as between wireless device 300A and wireless device 300B), by sending a request 1013, such as a positioning request, for determining a relative position of the plurality of second wireless devices to the fourth core network node 600D. The positioning request 1014A, 1014B may be sent via the first interface, such as using the LPP via the control plane.

The fourth core network node 600D may receive positioning results 1015A, 1015B, such as ranging results, from the second wireless device 300A and/or the second wireless device 300B, using the first interface such as using the LPP via the control plane. The positioning results 1015A, 1015B may be indicative of the relative position between the two second wireless devices 300A and 300B. The positioning result 1015A from the second wireless device 300A may comprise a relative distance and direction to the second wireless device 300B. The positioning result 1015B from the second wireless device 300B may comprise a relative distance and direction to the second wireless device 300A.

The fourth core network node 600D may send a positioning result message comprising the relative position of the plurality of second wireless devices to the third core network node 600C. The third core network node 600C sends the relative position of the plurality of second wireless devices 1017 to the first wireless device 300 via the service API, such as in a positioning result message.

In other words, according to the current disclosure the first wireless device may use a same service API for positioning of wireless devices, such as a location API (such as a north bound API) as an AF. Using the service API provides a good solution to check that the first wireless device is authorized to use the service API. To check whether an AF is authorized to use the API, the first core network node, such as the NEF, checks the second core network node, such as the UDM for a record. The first core network node could do the same for a wireless device.

The first core network node could either check the subscription record of the first wireless device in the second core network node, or check whether the wireless device belongs to a same group, such as a same Application group ID as the plurality of second wireless devices.

The Application Group configuration may be provisioned by an AF as described in 3GPP TS 23.304 v. 17.1.0.

Example benefits of using the service API for determining a position, such as a relative position, of the plurality of second wireless devices are:
The first wireless device does not need to be near the plurality of second wireless devices to obtain the position of the plurality of wireless devices. The first wireless device can even obtain the position from a different PLMN, such as from another country even.
The exposure functionality for an AF can be adapted for a wireless device.
The first core network node, such as the NEF, has a built-in functionality for authorizing an application function to use a service and this functionality can be adapted to also support wireless devices registered in the network.

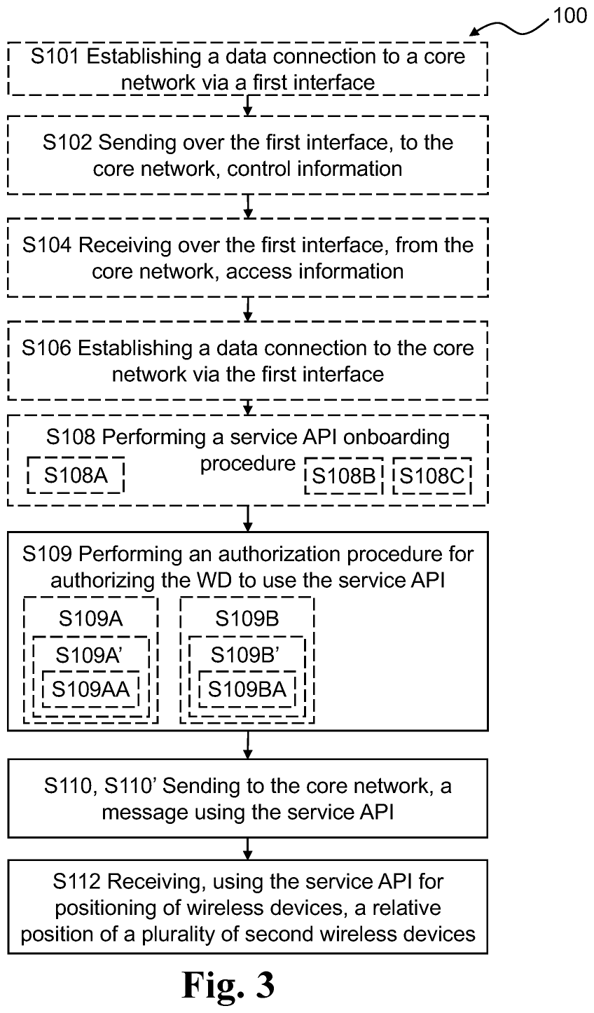

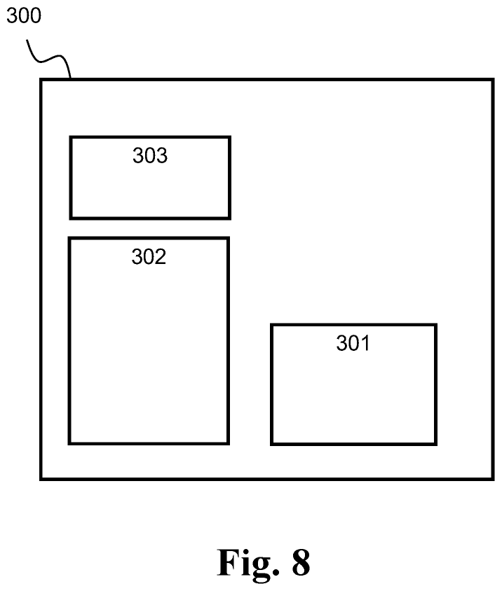

FIG. 3 shows a flow diagram of an example method 100, performed by a first wireless device, for accessing a service API. Service APIs are interfaces that provide a device or a program with a description of how to interact with a system in order to retrieve and/or exchange data within the system. The API service is the means with which a piece of software (such as a mobile app) interacts with a functionality stored in the software's backend, such as being stored on a server or made available by a third party. The first wireless device is the first wireless device disclosed herein, such as first wireless device 300 of FIG. 1, FIG. 2 and FIG. 8. The first wireless device intending to access and/or use the service API may herein also be referred to as a service API invoker or API invoker. In one or more example methods, the method 100 is performed by the first wireless device, for determining a relative position between a plurality of second wireless devices based on a positioning function of a core network, such as based on the LMF.

The method 100 comprises sending S102 over a first interface, to a core network, control information comprising an indication that the first wireless device intends to access the service API, such as a service API controlling node. The indication that the first wireless device may in one or more example methods be a request to access the service API, or a request for information needed to access the service API. In one or more example methods, the control information comprises one or more of an identifier identifying the first wireless device and information identifying the service API, such as the service API controlling node, that the first wireless device intends to access. The control information may be sent to a network node implementing an Access and mobility Management Function (AMF) of the core network. In one or more example methods, the first interface is a control channel. The first interface may be an N1 interface between the wireless device and the AMF. In one or more example methods, the control information is comprised in a registration request message, such as in an initial registration request message and/or in a registration request message due to mobility of the first wireless device. In one or more example methods, the first wireless device performs a registration request by sending a registration request message comprising an indication indicating that the first wireless device desires to access the service API. The indication indicating that the first wireless device desires to access the service API may be signaled as a wireless device capability exchange indicating that the first wireless device is capable of using the service API and/or an explicit indication that the first wireless device would like to use the service API. This step S102 corresponds to 1001 discussed in relation to FIG. 2.

The method 100 comprises receiving S104, over the first interface, access information required to access the service API, such as the service API controlling node. The access information is received from the core network, such as from the network node implementing the AMF of the core network. In one or more example methods, the access information comprises one or more of authorization information, authentication information, an address to the service API controlling node, and a fully qualified domain name, FQDN, for the service API controlling node. The authorization information may be indicative of which functions the first wireless device is allowed to use. The service that the first wireless device is allowed to use may for example be a positioning service, provided by such as the LMF. The authorization information may comprise onboarding enrolment information required to access the service API. The authentication information may comprise subscriber information and/or the CERT for identifying the first wireless device, such as a Root certificate authority (CA) certificate. The onboarding enrolment information may be used to authenticate and establish, such as via a second interface, a secure Transport Layer Security (TLS) communication with a service API controlling node, such as with a CAPIF core function, such as a Network Exposure Function (NEF), during an onboarding process. The onboarding enrolment information may comprise details of the CAPIF core function, such as an address, and/or the Root CA certificate. The onboarding enrolment information may further comprise onboarding credentials, such as an Open Authorization (OAuth) 2.0 access token. This step S104 corresponds to 1004 discussed in relation to FIG. 2. The control information and/or the access information is, in one or more example methods, transmitted using Non-Access Stratum (NAS) signaling.

In one or more example methods, the method 100 comprises establishing S101; S106 a data connection to the core network via NAS signaling over the first interface, such as performing a Protocol Data Unit (PDU) session establishment procedure. In one or more example methods, the data connection is established S101 prior to sending S102 the control information over the first interface. In one or more example methods, the data connection is established S106 after receiving S104 the access information required to access the service API over a first interface.

In one or more example methods, an already established data connection can be reused to access the service API controlling node.

The method 100 comprises, upon determining to use the service API, performing S108 over a second interface, based on the access information, a service API onboarding procedure. In one or more example methods, the second interface is an established data connection with the core network node, such as a data connection for transmitting user data, such as user data using for example a Hypertext Transfer Protocol (HTTP). The second interface may also be referred to as a PDU session. In one or more example methods, the onboarding procedure may be performed using data via the established data connection, such as the service API. In one or more example methods, the onboarding procedure may be performed using a data protocol, such as a Hypertext Transfer Protocol (HTTP). In one or more example methods, the onboarding procedure may be performed with a core network node implementing a function for onboarding wireless devices, such as with the service API controlling node.

In one or more example methods, performing S108 the onboarding procedure comprises establishing S108A a secure communication with the core network. The first wireless device and the service API controlling node, such as the NEF, may establish the secure communication based on TLS (Server side certificate authentication). The first wireless device may establish the secure communication based on the onboarding enrolment information.

In one or more example methods, performing S108 the onboarding procedure comprises sending S108B an onboarding request message to the core network, such as to the service API controlling. The onboarding request message may comprise the onboarding enrolment information, such as the onboarding credential (OAuth 2.0 access token) and/or the CERT. Upon the first wireless device's CERT, such as client certificate, being issued by a third party, the onboarding request message may additionally comprise the CERT. The first wireless device may generate a key pair {Private Key, Public key} and may provide the public key with the onboarding request message. This step S108B corresponds to 1005 discussed in relation to FIG. 2.

In one or more example methods, performing S108 the onboarding procedure comprises receiving S108C, from the core network, such as from the API controlling node, an onboarding response message. The onboarding response message may comprise an API invoker profile of the first wireless device. The API invoker profile may comprise one or more APIs, such as a list of one or more APIs, that the first wireless device can use. The onboarding response message may comprise one or more of an identifier (ID) identifying the first wireless device, such as an API invoker ID, assigned to the first wireless device by the service API controlling node, authentication and authorization information generated by the API controlling node, a certificate of the first wireless device and a secret generated by the API controlling node, such as an onboard secret of the first wireless device. This step S108C corresponds to 1007 discussed in relation to FIG. 2.

In one or more example methods, the service API is a service API of a core network node, such as a service API for positioning of wireless devices, such as an Exposure API for Ranging and Sidelink positioning.

In one or more example methods, the communication over the first interface uses a lower protocol layer, such as a lower protocol layer in a protocol stack, such as in a 5G control plane protocol stack, than a communication over the second interface.

In one or more example methods, the method 100 comprises, performing S109, over the second interface, an authorization procedure for authorizing the first wireless device to use the service API. This step S109 is similar to 1008 discussed in relation to FIG. 2.

In one or more example methods, performing S109 the authorization procedure comprises sending S109A, to the core network, an authorization request message to use the service API. The authorization request message may be a request to be authorized, by the network, to use the service API. In one or more example methods, the authorization request message to use the service API is sent over the established data connection.

In one or more example methods, the service API is a service API for positioning of wireless devices. In one or more example methods, such as when the method is performed for determining a relative position of the plurality of wireless devices, performing S109 the authorization procedure comprises sending S109A′, to the core network, such as to the service API controlling node, an authorization request message to use the service API for positioning of wireless devices, such as to use an Exposure API for Ranging and Sidelink positioning. The authorization request message may request the network, such as the service API controlling node, to perform an authorization validation to verify that the first wireless device is authorized to use the service API, such as the service API for positioning of wireless devices. The authorization request message may thus request the network to validate, such as with another network node and/or checking based on stored information, that the first wireless device is authorized to access a specific service API of the core network.

In one or more example methods, the authorization request message comprises access information for authenticating the first wireless device to use the service API for positioning of wireless devices. In one or more example methods, the access information comprises one or more of authorization information, authentication information, an address to a service API controlling node and a fully qualified domain name, FQDN, for the service API controlling node.

In one or more example methods, the authorization request message comprises authentication information for authenticating the first wireless device, such as for authenticating the first wireless device to use the service API for positioning of wireless devices. The authentication information may comprise one or more of an identifier identifying the first wireless device, such as the API invoker ID and/or a Mobile Station International Subscriber Directory Number (MSISDN), and the CERT of the first wireless device.

In one or more example methods, sending S109A, S109A′ comprises sending S109AA the authorization request to the service API controlling node, such as to the service API controlling node of the core network, such as to a node implementing the CAPIF core function, such as to the NEF.

In one or more example methods, performing S109 the authorization procedure comprises, upon the wireless device being authorized to use the service API, receiving S109B, from the core network, an authorization accept message. In one or more example methods, the core network is the service API controlling node. In one or more example methods, receiving S109B, S109B′ comprises receiving S109BA the authorization accept message from the service API controlling node. In one or more example methods, the authorization accept message is an authorization accept message to use the service API for positioning of wireless devices. In other words, in one or more example methods, the authorization accept message may indicate that the first wireless device is authorized to use the service API for positioning of wireless devices. The authorization accept message may indicate that the first wireless device is permitted to access and/or use the requested service API. In one or more example methods, the authorization accept message comprises dedicated information required to use the service API for positioning of wireless devices. In one or more example methods, the authorization accept message and/or the dedicated information may comprise a key and/or a secret generated by the second core network node, such as the core network node implementing the data management function. This step S109B corresponds to 1011 discussed in relation to FIG. 2.

In one or more example methods, the method 100 comprises, upon successfully finalizing the authorization procedure, such as upon receiving S109BA the authorization accept message, sending S110, S110′, to the core network, a message using the service API. In one or more example methods, the core network is the service API controlling node, such as a Network Exposure Function, NEF. In one or more example methods, the message is a positioning request for a plurality of second wireless devices. In one or more example methods, such as upon the message being a positioning request for a plurality of second wireless devices, the message identifies a plurality of second wireless devices, such as a plurality of second wireless devices between which a relative position is to be determined. In one or more example methods, the message requests a determination of the relative position of the plurality of second wireless devices. This step S110, S110′ is similar to 1012 discussed in relation to FIG. 2. In one or more example methods, the method 100 comprises, upon the first wireless device being authorized by the service API controlling node to access the relative position of the plurality of second wireless devices, receiving S112, using the service API for positioning of wireless devices, the relative position of the plurality of second wireless devices.

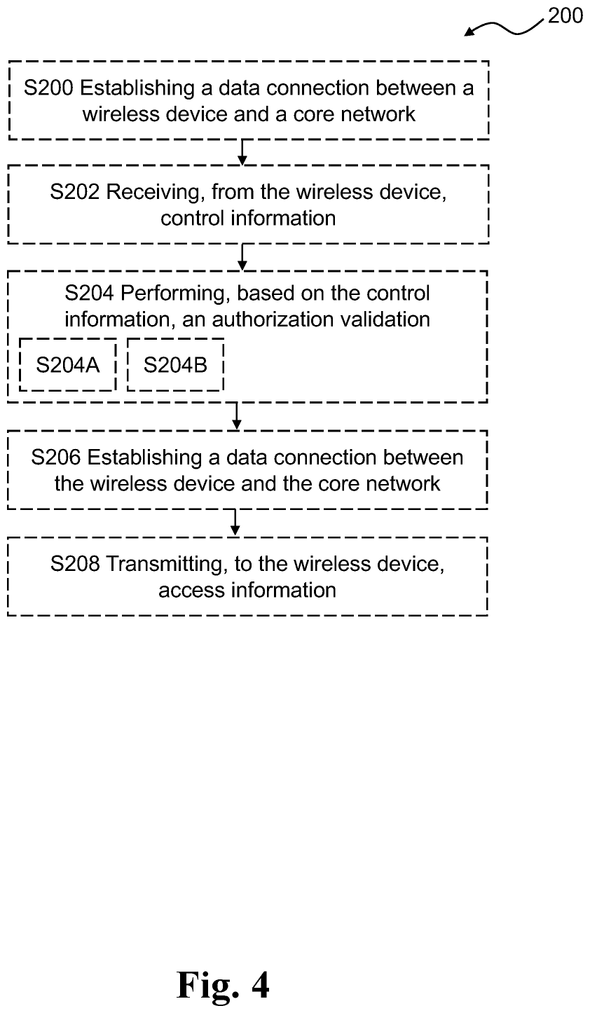

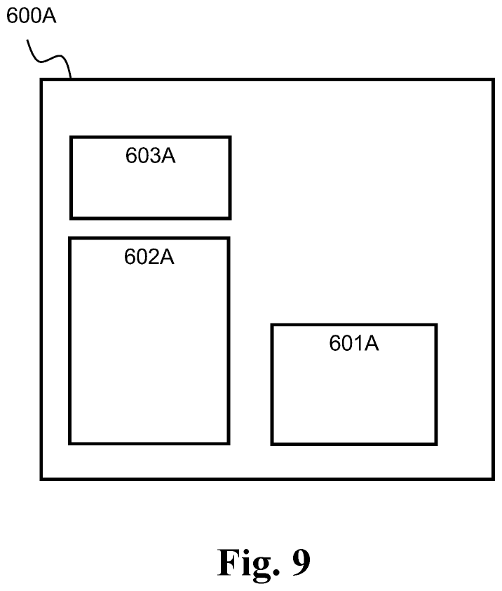

FIG. 4 shows a flow diagram of an example method 200, performed by a first core network node, for enabling a wireless device to access a service API of the core network. The first core network node is the core network node disclosed herein, such as first core network node 600A of FIG. 1, FIG. 2 and FIG. 9. The first core network node may be a core network node implementing an AMF.

In one or more example methods, the method 200 comprises receiving S202, from a wireless device, control information comprising an indication that the wireless device intends to access the service API, such as the service API controlling node. In one or more example methods, the control information comprises one or more of an identifier identifying the first wireless device and information identifying the service API that the first wireless device intends to access. The control information may be sent to a network node implementing an Access and mobility Management Function (AMF) of the core network. In one or more example methods, the first interface is a control channel, such as a control channel for 3GPP control signaling, such as for NAS signaling. The first interface may be an N1 interface between the wireless device and the AMF. In one or more example methods, the control information is comprised in a registration request message, such as in an initial registration request message and/or in a registration request message due to mobility of the first wireless device. In one or more example methods, the first wireless device performs a registration request comprising an indication indicating that the first wireless device desires to access the service API. The indication indicating that the first wireless device desires to access the service API may be signaled as a wireless device capability exchange indicating that the first wireless device is capable of using the service API and/or an explicit indication that the first wireless device would like to use the service API. This step S202 corresponds to 1001 discussed in relation to FIG. 2.

In one or more example methods, the method 200 comprises performing S204, based on the control information, a first authorization validation with a second core network node, for authorizing the wireless device to access the service API. The second core network node may be the network node implementing the data management function, such as a network node implementing a Unified Data Management (UDM) function, or a network node implementing any other network function that has the functionality to validate and provide needed information towards the wireless device. In one or more example methods, performing S204 authorization procedure comprises sending S204A, to the second core network node, based on the control information, a first authorization validation request message for the wireless device to access the service API, such as the service API controlling node. In one or more example methods, performing S204 the authorization validation comprises checking with the second network node, such as with the network node implementing the data management function, whether the first wireless device is authorized to access the service API, such as accessing any service API. The validation may be done by the second core network node by comparing the control information with subscription information for the first wireless device. It may also be done by other Network function that has the functionality to validate and provide needed information towards the UE. This step S204A corresponds to 1002 discussed in relation to FIG. 2.

In one or more example methods, performing S204 the authorization procedure comprises, upon the wireless device being authorized to use the service API, receiving S204B, from the second core network node, access information required to access the service API, such as the service API controlling node. In one or more example methods, the access information comprises one or more of authorization information, authentication information, an address to a service API controlling node, and a fully qualified domain name, FQDN, for the service API controlling node. The authorization information may be indicative of which functions the first wireless device is allowed to use. The authorization information may comprise onboarding enrolment information required to access the service API. The authentication information may comprise one or more of an identifier for identifying the first wireless device, subscriber information and/or the CERT for identifying the first wireless device. The onboarding enrolment information may comprise details of the CAPIF core function, such as an address of CAPIF core function, and/or a Root CA certificate. The onboarding enrolment information may further comprise onboarding credentials, such as the OAuth 2.0 access token. This step S204B corresponds to 1003 discussed in relation to FIG. 2.

In one or more example methods, the method 200 comprises, upon the wireless device being authorized to access the service API, such as the service API controlling node, transmitting S208, to the first wireless device, the access information required to access the service API. This step S208 corresponds to 1004 discussed in relation to FIG. 2.

In one or more example methods, the method 100 comprises establishing S200; S206 a data connection between the wireless device and the core network. In one or more example methods, the data connection is established S200 prior to receiving S202, from the wireless device, control information. In one or more example methods, the data connection is established S206 after performing S204 the authorization procedure.

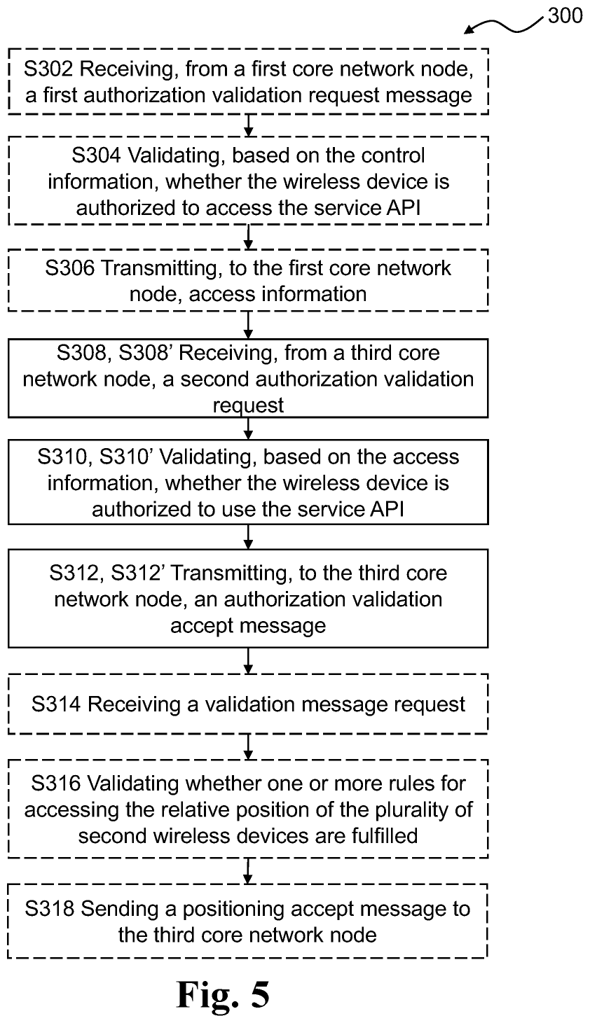

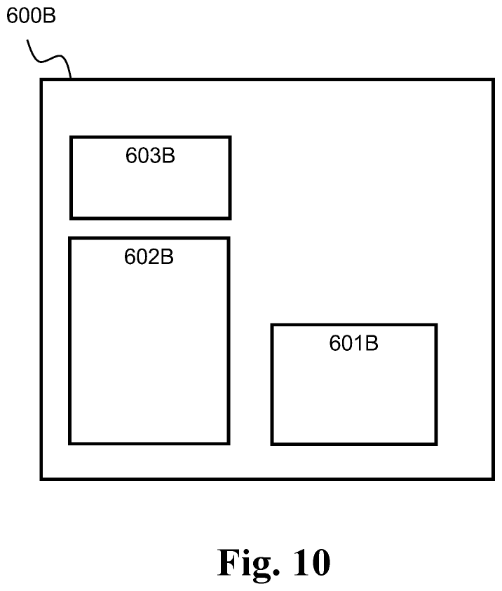

FIG. 5 shows a flow diagram of an example method 300, performed by a second core network node, for enabling a wireless device to access a service API of a core network. In one or more example methods, the method 300, performed by the second core network node, is for enabling a first wireless device to determine a relative position between a plurality of second wireless devices based on a positioning function of the core network. The second core network node is the second core network node disclosed herein, such as second core network node 600B of FIG. 1, FIG. 2 and FIG. 10. In one or more example methods, the second core network node is a network node implementing a data management function, such as a network node holding subscriber information of the wireless device. In one or more example methods, the data management function is a UDM and/or a PCF and/or an AUSF and/or a 5G Direct Discovery Name Management Function (DDNMF).

In one or more example methods, the method 300 comprises receiving S302, from a first core network node, a first authorization validation request message, for authorizing the first wireless device to access the service API, such as to access a service API controlling node. In one or more example methods, the first authorization validation request comprises control information.

In one or more example methods, the control information comprises one or more of an identifier identifying the wireless device and an information identifying the service API that the wireless device intends to access and/or use. This step S302 corresponds to 1002 discussed in relation to FIG. 2.

In one or more example methods, the method 300 comprises validating S304, based on the control information, whether the wireless device is authorized to access the service API, such as the service API controlling node. In one or more example methods, validating S304 comprises comparing the received control information against stored information, such as subscription information, whether the first wireless device is authorized to access the service API, such as the service API controlling node.

In one or more example methods, the method 300 comprises, upon the wireless device being authorized to access the service API, such as the service API controlling node, transmitting S306, to the first core network node, access information required to access the service API, such as the service API controlling node. In one or more example methods, the access information comprises one or more of authorization information, authentication information, an address to a service API controlling node and a FQDN for the service API controlling node. This step S306 is similar to 1003 discussed in relation to FIG. 2.

In one or more example methods, the method 300 comprises receiving S308, from a third core network node, such as from the service API controlling node, a second authorization validation request message, for authorizing the wireless device to use the service API, such as to use a specific service API, such as a specific service API controlled by the service API controlling node. In one or more example methods, the second authorization validation request comprises the access information. This step S308 corresponds to 1009 discussed in relation to FIG. 2. In one or more example methods, the method 300 comprises receiving S308′, from the service API controlling node, a validation request message to validate whether the first wireless device is authorized to use the service API for positioning of wireless devices. In one or more example methods, the validation request message comprises access information for accessing the service API for positioning of wireless devices. The access information may comprise authentication information for identifying the first wireless device. The authentication information may comprise one or more of an identifier identifying the first wireless device, such as the API invoker ID and/or a Mobile Station International Subscriber Directory Number (MSISDN), and the CERT of the first wireless device. In other words, the second authorization validation request message may be the validation request message to validate whether the first wireless device is authorized to use the service API for positioning of wireless devices.

In one or more example methods, the method 300 comprises validating S310, based on the access information, whether the wireless device is authorized to use the service API. In one or more example methods, validating S310 comprises validating S310′ whether the wireless device is authorized to use the service API is based on the access information and one or more rules and/or subscription data.

In one or more example methods, the method 300 comprises, upon the wireless device being authorized to use the service API, transmitting S312, S312′, to the third core network node, such as to the service API controlling node, an authorization validation accept message. In one or more example methods, the authorization validation accept message may indicate that the wireless device is authorized to use the service API for positioning of wireless devices. In one or more example methods, the authorization validation accept message comprises dedicated information required to use the service API, such as the service API for positioning of wireless devices. In one or more example methods, the dedicated information comprises one or more of the identifier identifying the first wireless device, such as the API invoker ID and/or the CERT of the first wireless device. In one or more example methods, the dedicated information may comprise a key and/or a secret generated by the second core network node. This step S312, S312′ corresponds to 1010 discussed in relation to FIG. 2.

In one or more example methods, the method 300 comprises receiving S314, from a third core network node, such as from a service API controlling node, a request message to validate that the first wireless device is authorized to access the relative position of the plurality of second wireless device. In one or more example methods, the validation message comprises information identifying the plurality of second devices. The information identifying the plurality of second devices, may be an identity, such as a respective MSISDN or a respective application user ID or a respective device-to-device ID of the plurality of second wireless devices, such as of a primary second wireless device WD A and a secondary second wireless device WD B.

In one or more example methods, the method 300 comprises validating S316 based on the dedicated information required to use the service API and the information identifying the plurality of second wireless devices, whether one or more rules for accessing the relative position of the plurality of the second wireless devices are fulfilled.

In one or more example methods, the one or more rules comprises one or more of:
the relative position of the plurality of second wireless devices not being restricted,
the first wireless device belonging to a same group as the plurality of second wireless devices, and
the first wireless device being specifically authorized to access the relative position of the plurality of second wireless devices.

In one or more examples, the group can be defined by a third party, such as by a third party Application Function (AF), such as described in 3GPP TS 23.304 v. 17.1.0. The wireless devices may for example be grouped based on the MSISDNs of the wireless devices. The rule may for example indicate that these MSISDN are in the same group.

In one or more examples, a number of subscriptions may be grouped. For example, all subscriptions belonging to for example police, or a firefighter brigade may be grouped in the same group.

In one or more example methods, the wireless devices may be grouped by a third party AF, such as a game register. The group may for example indicate that the wireless devices in the group are players in the same group, such as in a same team or playing the same game, for an active game period.

In one or more example methods, the method 300 comprises, upon the first wireless device being authorized to access the relative position of the plurality of second wireless devices, sending S318 a positioning accept message to the service API controlling node. In one or more example methods, the positioning accept message indicates that the first wireless device is authorized to access the relative position of the plurality of second wireless devices. In one or more example methods, the service API controlling node is the third core network node.

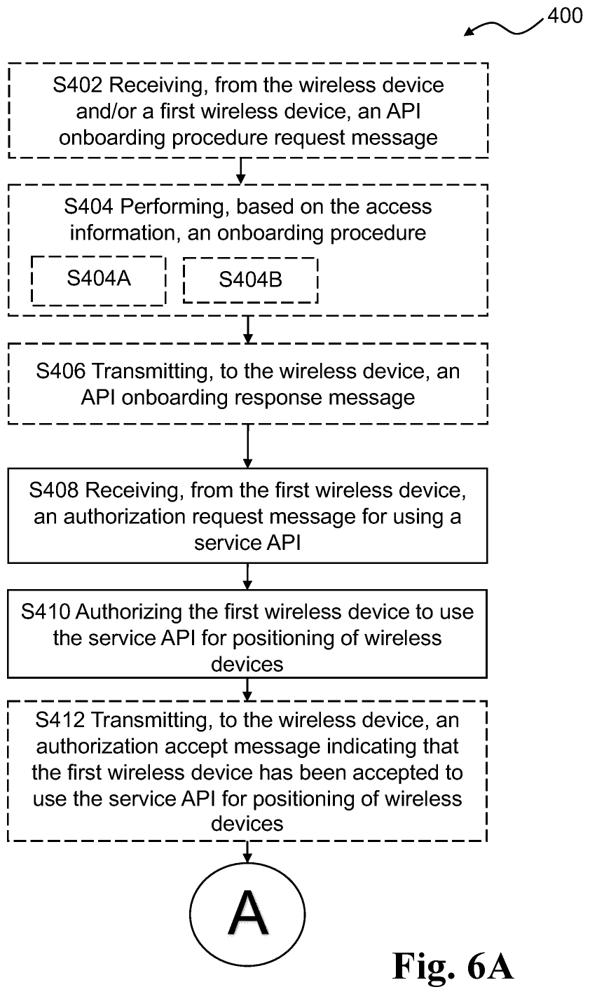

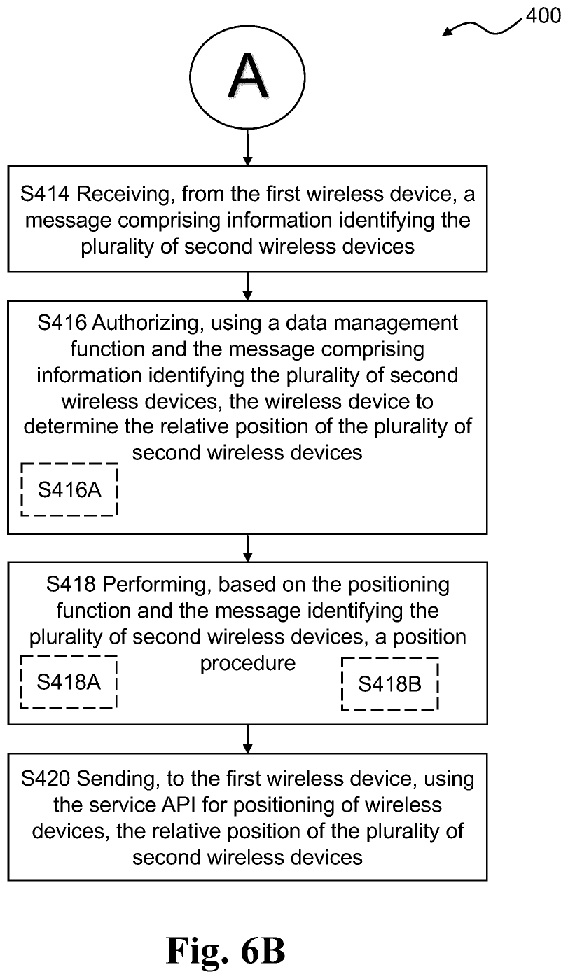

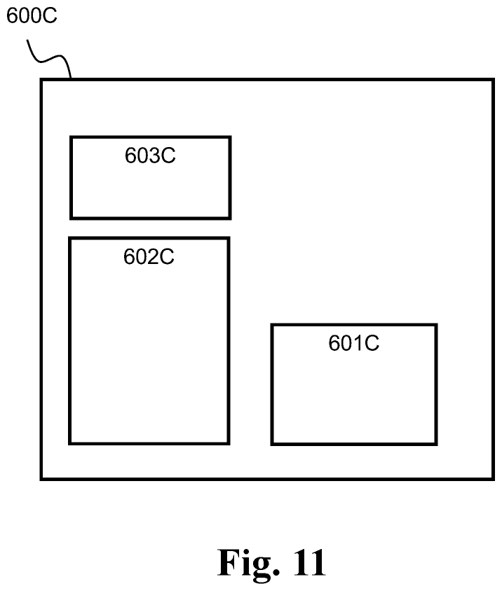

FIG. 6 shows a flow diagram of an example method 400, performed by a third core network node, for enabling a wireless device to access a service API of a core network. In one or more example methods, the method is a method for enabling a first wireless device to determine a relative position between a plurality of second wireless devices based on a positioning function of a core network, such as an LMF. In one or more example methods, the third core network node is the third core network node disclosed herein, such as third core network node 600C of FIG. 1, FIG. 2 and FIG. 11. In one or more example methods, the third core network node is a service API controlling node, such as network node implementing a CAPIF core function, such as a NEF.

In one or more example methods, the method 400 comprises receiving S402, from the wireless device, such as from the first wireless device, over an established data connection, an API onboarding request message. In one or more example methods, the API onboarding request message comprises access information for accessing the service API, such as accessing the service API controlling node. The onboarding request message may comprise the onboarding enrolment information, such as the onboarding credential (OAuth 2.0 access token) and/or the CERT. Upon the first wireless device's CERT, such as client certificate, being issued by a third party, the first wireless device may additionally comprise the CERT. The onboarding request message may, in one or more example methods, comprise a public key generated by the wireless device. The data connection may be established over the second interface. This step S402 corresponds to 1005 discussed in relation to FIG. 2.

In one or more example methods, the method 400 comprises performing S404, based on the access information, an onboarding procedure for authorizing the wireless device to use the service API. Performing S404 the onboarding procedure may comprise validating the onboarding enrolment information, such as the enrolment credential (such as an OAuth 2.0 access token) and/or the CERT. In one or more example methods, upon validation of the onboarding enrolment information, such as of the enrolment credential is successful, the third core network node generates a profile, such as an API invoker's profile as specified in 3GPP TS 23.222 v17.5.0, for the first wireless device. The profile may comprise a selected method for authentication and authorization between the first wireless device and the service API controlling node. The third core network node may generate a certificate for the first wireless device intending to access the service API, herein also referred to as the API invoker, on its own, for the assigned first wireless device identity and public key. The certificate is to be used by the first wireless device for subsequent authentication procedures with the service API controlling node and may be used for establishing a secure connection and authentication with the API Exposing Function (AEF) of the service API controlling node. In one or more example methods, the third network node may generate the secret, such as the Onboard_Secret, upon the service API uses Method 3 (as specified in clause 6.5.2.3 of 3GPP TS 33.122 rel-16) for CAPIF-2e security. A value of the Onboard_Secret may remain the same during the lifetime of the onboarding, and may be bound to a specific wireless device ID, such as a specific API Invoker ID, generated by the third core network node. In one or more example methods, upon the third core network node, such as the CAPIF Core Function, trusting the issuer of the wireless device's client certificate, then the third core network node includes the provided certificate in the profile, such as in the API invoker's profile. In one or more example methods, it is up to a CAPIF domain policy to accept the client certificates issued by third party. This step S404 corresponds to 1006 discussed in relation to FIG. 2.

In one or more example methods, performing S404 the onboarding procedure for authorizing the wireless device to use the service API comprises sending S404A, to a second core network node, based on the access information, an authorization validation request message for the wireless device to use the service API, such as for accessing the service API controlling node.

In one or more example methods, the API onboarding procedure request message comprises access information authenticating the first wireless device to use a service API for positioning of wireless devices. In one or more example methods, the access information comprises one or more of authorization information, authentication information, the address to the service API controlling node, and the FQDN for the service API controlling node.

In one or more example methods, performing S404 the onboarding procedure for authorizing the wireless device to use the service API, upon the wireless device being authorized to use the service API, comprises receiving S404B, from the second core network node, an API onboarding response message.

In one or more example methods, the method 400 comprises, upon the wireless device being authorized to access the service API, such as the service API controlling node, transmitting S406, to the wireless device, over the established data connection, an API onboarding response message. The onboarding response message may comprise an information from the API invoker profile of the first wireless device. The API invoker profile may comprise one or more APIs, such as a list of one or more APIs, that the first wireless device can use. The onboarding response message may comprise one or more of an identifier (ID) identifying the first wireless device, such as an API invoker ID, assigned to the first wireless device by the service API controlling node, authentication and authorization information generated by the API controlling node, a certificate of the first wireless device and a secret generated by the API controlling node, such as an onboard secret of the first wireless device.

In one or more example methods, such as when the method is for enabling a first wireless device to determine a relative position between a plurality of second wireless devices based on a positioning function of a core network, the method comprises receiving S408, from the first wireless device, over the established data connection, an authorization request message for using the service API. The authorization request message may comprise access information authenticating the first wireless device. The authorization request message may request the third core network node to validate, based on the access information, that the first wireless device is authorized, such as is allowed, to use, such as to access, the service API. The access information authenticating the first wireless device may comprise one or more of an identifier identifying the first wireless device, such as an identifier proving the identity of the first wireless device, such as the API invoker ID and/or a MSISDN, and the CERT of the first wireless device. The API invoker ID may be a temporary ID assigned to the first wireless device. The MSISDN may be a static address of the first wireless device, such as a phone number. Based on the access information authenticating the first wireless device, the third core network node may authorize the first wireless device, such as may check the identity of the first wireless device, against for example a list of wireless devices being allowed to use the service API.

In one or more example methods, the method 400 comprises authorizing S410, using a data management function and based on the access information, the first wireless device to access the service API for positioning of wireless devices.

In one or more example methods, authorizing S410 the first wireless device to access the service API for positioning of wireless devices comprises sending S410A, to the network node implementing a data management function, an authorization validation request message. In one or more example methods, the authorization validation request message comprises the authentication information to validate whether the first wireless device is authorized to access the service API for positioning of wireless devices. This step S410 corresponds to 1008 discussed in relation to FIG. 2.

In one or more example methods, authorizing S410 the first wireless device to use the service API for positioning of wireless devices comprises, upon the first wireless device being authorized to access the service API for positioning of wireless devices, receiving S410B, from the network node implementing the data management function, an authorization validation accept message.

In one or more example methods, such as upon the first wireless device being authorized to access the service API for positioning of wireless devices, the method 400 comprises transmitting S412, to the first wireless device, using the service API for positioning of wireless devices, an authorization accept message. In one or more example methods, the authorization accept message indicates that the first wireless device has been accepted to use the service API for positioning of wireless devices. In one or more example methods, the authorization accept message comprises dedicated information required to use the service API for positioning of wireless devices. In one or more example methods, the authorization accept message and/or the dedicated information may comprise a security method to be used, a key and/or a secret. In one or more example methods, the secret may be generated by the second core network node, such as the core network node implementing the data management function, and/or the third core network node, such as the service API controlling node. This step S412 corresponds to 1011 discussed in relation to FIG. 2.

In one or more example methods, the method 400 comprises receiving S414, from the first wireless device, using the service API for positioning of wireless devices, a message comprising information identifying the plurality of second wireless devices. In one or more example methods, the message requests a determination of the relative position of the plurality of second wireless devices. The information identifying the plurality of second devices, may be a respective identity, such as a respective MSISDN or a respective application user ID or a respective device-to-device ID, of the plurality of second wireless devices, such as of a primary second wireless device WD A and a secondary second wireless device WD B. This step S414 is similar to 1012 discussed in relation to FIG. 2.

In one or more example methods, the method 400 comprises authorizing S416, using a data management function and the message comprising information identifying the plurality of second wireless devices, the first wireless device to determine the relative position of the plurality of second wireless devices. In one or more example methods, the data management function is the UDM and/or the PCF and/or the DDNMF.

In one of more example methods, authorizing S416 comprises validating S416A, with the data management function, such as with the second core network node implementing the data management function, and based on the message comprising the identifier identifying the plurality of second wireless devices, whether one or more rules for accessing the relative position of the plurality of second wireless devices are fulfilled.

In one or more example methods, the one or more rules comprises one or more of:
the relative position of the plurality of second wireless devices not being restricted,
the first wireless device belonging to a same group as the plurality of second wireless devices, and
the first wireless device being specifically authorized to access the relative position of the plurality of second wireless devices.

In one or more examples, the group can be defined by a third party, such as by a third party AF, such as described in 3GPP TS 23.304 v 17.1.0. The wireless devices may for example be grouped based on the MSISDNs of the wireless devices. The rule may for example indicate that these MSISDN are in the same group.

In one or more examples, a number of subscriptions may be grouped. For example, all subscriptions belonging to for example police, or a firefighter brigade may be grouped in the same group.

In one or more example methods, the wireless devices may be grouped by a third party AF, such as a game register. The group may for example indicate that the wireless devices in the group are players in the same group, such as in a same team or playing the same game, for an active game period.

In one or more example methods, the method 400 comprises, upon the first wireless device being authorized to determine the relative position of the plurality of second wireless devices, performing S418, based on the positioning function and the message identifying the plurality of second wireless devices, a positioning procedure for determining the relative position of the plurality of second wireless devices. This step S418 is similar to 1013 and 1016 discussed in relation to FIG. 2.

In one or more example methods, performing S418 the positioning procedure comprises sending S418A, to the network node implementing the positioning function, such as to a core network node implementing the LMF, based on the message identifying the plurality of second wireless devices, a request for determining a relative position of the plurality of second wireless devices, such as between a primary second network node and a secondary second network node. In one or more example methods, the request for determining the relative position of the plurality of second wireless devices may for example be a ranging request. This step S418A corresponds to 1013 discussed in relation to FIG. 2.

In one or more example methods, performing S418 the positioning procedure comprises, upon the first wireless device being authorized to access the relative position of the plurality of second wireless devices, receiving S418B, from the network node implementing the positioning function of the core network, a positioning result message. In one or more example methods, the positioning result message comprises the relative position of the plurality of second wireless devices, such as between the primary second wireless device and the secondary second wireless device. In one or more example methods, the positioning result message is a ranging result message. The relative position may, in one or more example methods, comprise a relative distance and/or a direction between the plurality of second wireless devices, such as between the primary second network node and the secondary second network node. This step S418B corresponds to 1016 discussed in relation to FIG. 2.

In one or more example methods, the method 400 comprises sending S420, to the first wireless device, using the service API for positioning of wireless devices, the relative position of the plurality of second wireless devices. The relative position may, in one or more example methods, comprise a relative distance and/or a direction between the plurality of second wireless devices, such as between the primary second network node and the secondary second network node. This step S420 corresponds to 1017 discussed in relation to FIG. 2.

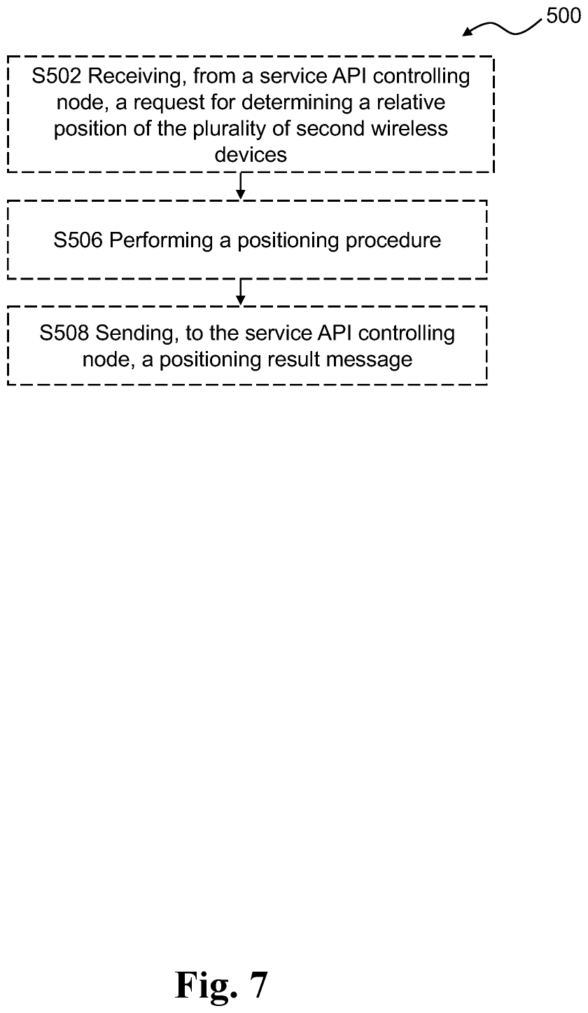

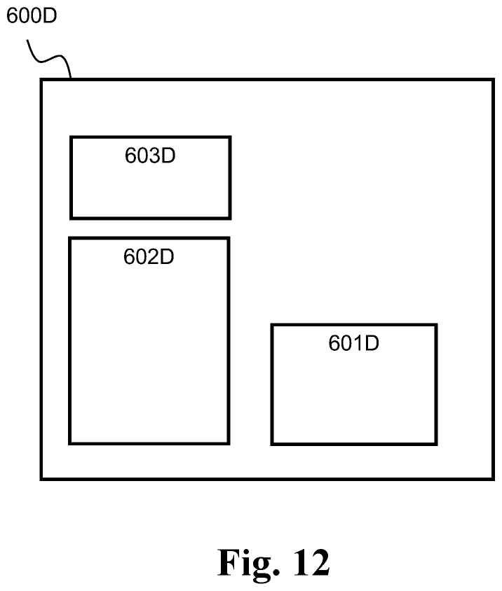

FIG. 7 shows a flow diagram of an example method 500, performed by a fourth core network node, for enabling a first wireless device to determine a relative position between a plurality of second wireless devices. In one or more example methods, the fourth core network node is the fourth core network node disclosed herein, such as fourth core network node 600D of FIG. 1, FIG. 2 and FIG. 12. In one or more example methods, the fourth core network node is a network node implementing a positioning function, such as an LMF.

The method 500 performed by a network node implementing a positioning function of a core network, for enabling a first wireless device to determine a relative position between a plurality of second wireless devices, comprises

In one or more examples, the method 500 comprises receiving S502, from a service API controlling node, a request for determining a relative position of the plurality of second wireless devices. In one or more examples, the request comprises information identifying the plurality of second wireless devices, such as a primary second wireless device and a secondary second wireless device. In one or more example methods, the request for determining the relative position of the plurality of second wireless devices may for example be a ranging request. This step S502 corresponds to 1013 discussed in relation to FIG. 2. In one or more example methods, the method 500 comprises performing S506 a positioning procedure to determine the relative position between a plurality of second wireless devices. Performing the positioning procedure may comprise sending ranging request to the respective second wireless devices and/or receiving ranging results from the respective second wireless devices. This step S506 is similar to 1014A, 1014B, 1015A, and/or 1015B discussed in relation to FIG. 2.

In one or more example methods, the method 500 comprises sending S508, to the service API controlling node, a positioning result message. In one or more example methods, the positioning result message comprises the relative position of the plurality of second wireless devices. This step S508 corresponds to 1016 discussed in relation to FIG. 2.

FIG. 8 shows a block diagram of an example wireless device 300 according to the disclosure, such as the first wireless device disclosed herein. The wireless device 300 comprises memory circuitry 301, processor circuitry 302, and a wireless interface 303. The wireless device 300 may be configured to perform any of the methods disclosed in FIG. 3. In other words, the wireless device 300 may be configured for accessing a service API, such as a service API for positioning of wireless devices. In one or more example methods, the wireless device 300 may be configured for determining a relative position between a plurality of second wireless devices based on a positioning function of a core network.

The wireless device 300 is configured to communicate with a network node, such as the wireless device disclosed herein, using a wireless communication system.

The wireless device 300 is configured to send (such as via the wireless interface 303 over a second interface, to a service API controlling node, over an established data connection, an authorization request message to use a service API for positioning of wireless devices, the authorization request message comprising access information for authenticating the first wireless device to use the service API for positioning of wireless devices.

The wireless device 300 is configured to, upon receiving an authorization accept message to use the service API for positioning of wireless devices, send (such as via the wireless interface 303), to the service API controlling node using the service API for positioning of wireless devices, a message identifying the plurality of second wireless devices, wherein the message requests a determination of the relative position of the plurality of second wireless devices.

The wireless device 300 is configured to, upon the first wireless device being authorized by the service API controlling node to access the relative position of the plurality of second wireless devices, receive (such as via the wireless interface 303) using the service API for positioning of wireless devices, the relative position of the plurality of second wireless devices.

The wireless interface 303 is configured for wireless communications via a wireless communication system, such as a 3GPP system, such as a 3GPP system supporting one or more of: LTE, E-UTRA, New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands.

The wireless device 300 is optionally configured to perform any of the operations disclosed in FIG. 3 (such as any one or more of S101, S102, S104, S106, S108, S108A, S108B, S108C,

S109, S109A, S109A′, S109AA, S109B, S109B′, S109BA, S110, S110′, S112). The operations of the wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the wireless device 300 may be considered a method that the wireless device 300 is configured to carry out. Also, while the described functions and operations may be implemented in software, such functionality may also be carried out via dedicated hardware or firmware, or some combination of hardware, firmware and/or software. Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 8). Memory circuitry 301 is considered a non-transitory computer readable medium.

Memory circuitry 301 may be configured to store information (such as access information, onboarding information etc.) in a part of the memory.

FIG. 9 shows a block diagram of an example first core network node 600A, such as a core network node implementing an AMF, according to the disclosure. The first core network node 600A comprises memory circuitry 601A, processor circuitry 602A, and an interface 603A. The first core network node 600A may be configured to perform any of the methods disclosed in FIG. 4. In other words, the first core network node 600A may be configured for enabling a wireless device to access a service API of the core network.

The first core network node 600A is configured to communicate with a wireless device, such as the first wireless device disclosed herein, using a wireless communication system.

The interface 603A may be a wired interface and/or a wireless interface configured for wireless communications via a wireless communication system, such as a 3GPP system, such as a 3GPP system supporting one or more of: LTE, E-UTRA, New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands.

In one or more examples, the first core network node 600A is configured to receive, for example via the wireless interface 603A, from a wireless device, control information comprising an indication that the wireless device intends to access the service API.

In one or more examples, the first core network node 600A is configured to perform, for example using the processor circuitry 602A, based on the control information, a first authorization validation with a second core network node, for authorizing the wireless device to access the service API.

In one or more examples, the first core network node 600A is configured to, upon the wireless device being authorized to access the service API, transmit, for example via the wireless interface 603A, to the wireless device, access information required to access the service API. Processor circuitry 602A is optionally configured to perform any of the operations disclosed in FIG. 4 (such as any one or more of S200, S202, S204, S204A, S204B, S206, S208). The operations of the first core network node 600A may be embodied in the form of executable logic routines (for example, lines of code, software programs, etc.) that are stored on a non-transitory computer readable medium (for example, memory circuitry 601A) and are executed by processor circuitry 602A).

Furthermore, the operations of the first core network node 600A may be considered a method that the first core network node 600A is configured to carry out. Also, while the described functions and operations may be implemented in software, such functionality may also be carried out via dedicated hardware or firmware, or some combination of hardware, firmware

Memory circuitry 601A may be one or more of a buffer, a flash memory, a hard drive, a removable media, a volatile memory, a non-volatile memory, a random access memory (RAM), or other suitable device. In a typical arrangement, memory circuitry 601A may include a non-volatile memory for long term data storage and a volatile memory that functions as system memory for processor circuitry 602A. Memory circuitry 601A may exchange data with processor circuitry 602A over a data bus. Control lines and an address bus between memory circuitry 601A and processor circuitry 602A also may be present (not shown in FIG. 9). Memory circuitry 601A is considered a non-transitory computer readable medium.

Memory circuitry 601A may be configured to store information (such as access information, onboarding information etc.) in a part of the memory.

FIG. 10 shows a block diagram of an example second core network node 600B, such as a core network node implementing a data management function, according to the disclosure. The second core network node 600B comprises memory circuitry 601A, processor circuitry 602B, and an interface 603B. The second core network node 600B may be configured to perform any of the methods disclosed in FIG. 4. In other words, the second core network node 600B may be configured for enabling a wireless device to access a service API of the core network and/or for enabling a first wireless device to determine a relative position between a plurality of second wireless devices.

The second core network node 600B is configured to communicate with a wireless device, such as the first wireless device disclosed herein, using a wireless communication system. The interface 603B may be a wired interface and/or a wireless interface configured for wireless communications via a wireless communication system, such as a 3GPP system, such as a 3GPP system supporting one or more of: LTE, E-UTRA, New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands.

The second core network node 600B is configured to receive, for example via the interface 603B, from a service API controlling node, a validation request message to validate whether the first wireless device is authorized to use a service API for positioning of wireless devices, wherein the validation request message comprises access information for accessing the service API for positioning of wireless devices.

The second core network node 600B is configured to validate, for example using the processor circuitry 602B and/or the interface 603B, based on the access information and one or more rules and/or subscription data, whether the wireless device is authorized to use the service API for positioning of wireless devices.

The second core network node 600B is configured to, upon the wireless device being authorized to use the service API for positioning of wireless devices, transmit, for example via the interface 603B, to the service API controlling node, an authorization validation accept message, wherein the authorization validation accept message comprises dedicated information required to use the service API for positioning of wireless devices.

Processor circuitry 602B is optionally configured to perform any of the operations disclosed in FIG. 5 (such as any one or more of S302, S304, S306, S308, S308′, S310, S310′, S312, S312′,

S314, S316, S318). The operations of the second core network node 600B may be embodied in the form of executable logic routines (for example, lines of code, software programs, etc.) that are stored on a non-transitory computer readable medium (for example, memory circuitry 601B) and are executed by processor circuitry 602B).

Furthermore, the operations of the second core network node 600B may be considered a method that the second core network node 600B is configured to carry out. Also, while the described functions and operations may be implemented in software, such functionality may also be carried out via dedicated hardware or firmware, or some combination of hardware, firmware and/or software.

Memory circuitry 601B may be one or more of a buffer, a flash memory, a hard drive, a removable media, a volatile memory, a non-volatile memory, a random access memory (RAM), or other suitable device. In a typical arrangement, memory circuitry 601B may include a non-volatile memory for long term data storage and a volatile memory that functions as system memory for processor circuitry 602B. Memory circuitry 601B may exchange data with processor circuitry 602B over a data bus. Control lines and an address bus between memory circuitry 601B and processor circuitry 602B also may be present (not shown in FIG. 10). Memory circuitry 601B is considered a non-transitory computer readable medium.

Memory circuitry 601B may be configured to store information (such as access information, onboarding information etc.) in a part of the memory.

FIG. 11 shows a block diagram of an example third core network node 600C, such as a service API controlling node, according to the disclosure. The third core network node 600C comprises memory circuitry 601C, processor circuitry 602C, and an interface 603C. The third core network node 600C may be configured to perform any of the methods disclosed in FIG. 4. In other words, the third core network node 600C may be configured for enabling a wireless device to access a service API of the core network and/or for enabling a first wireless device to determine a relative position between a plurality of second wireless devices based on a positioning function of a core network.

The third core network node 600C is configured to communicate with a wireless device, such as the first wireless device disclosed herein, using a wireless communication system.

The interface 603C may be a wired interface and/or a wireless interface configured for wireless communications via a wireless communication system, such as a 3GPP system, such as a 3GPP system supporting one or more of: LTE, E-UTRA, New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands.

The third core network node 600C is configured to receive, for example via the interface 603C, from the first wireless device, over an established data connection, an authorization request message for using a service API, the authorization request message comprising access information authenticating the first wireless device to use the service API for positioning of wireless devices.

The third core network node 600C is configured to authorize, for example using the processor circuitry 602C and/or the interface 603C, using a data management function and based on the access information, the first wireless device to use the service API for positioning of wireless devices.

The third core network node 600C is configured to receive, for example via the interface 603C, from the first wireless device, using the service API for positioning of wireless devices, a message comprising information identifying the plurality of second wireless devices, wherein the message requests a determination of the relative position of the plurality of second wireless devices.

The third core network node 600C is configured to authorize, for example using the processor circuitry 602C and/or the interface 603C, using a data management function and the message comprising information identifying the plurality of second wireless devices, the first wireless device to determine the relative position of the plurality of second wireless devices.

The third core network node 600C is configured to, upon the first wireless device being authorized to determine the relative position of the plurality of second wireless devices, perform, for example using the processor circuitry 602C, based on the positioning function and the message identifying the plurality of second wireless devices, a positioning procedure for determining the relative position of the plurality of second wireless devices.

The third core network node 600C is configured to, upon the wireless device being authorized to access the service API, send, for example via the interface 603C, to the first wireless device, using the service API for positioning of wireless devices, the relative position of the plurality of second wireless devices.

Processor circuitry 602C is optionally configured to perform any of the operations disclosed in FIG. 6A-6B (such as any one or more of S402, S404, S404A, S404B, S406). The operations of the second core network node 600B may be embodied in the form of executable logic routines (for example, lines of code, software programs, etc.) that are stored on a non-transitory computer readable medium (for example, memory circuitry 601C) and are executed by processor circuitry 602C).

Furthermore, the operations of the second core network node 600C may be considered a method that the second core network node 600C is configured to carry out. Also, while the described functions and operations may be implemented in software, such functionality may also be carried out via dedicated hardware or firmware, or some combination of hardware, firmware and/or software.

Memory circuitry 601C may be one or more of a buffer, a flash memory, a hard drive, a removable media, a volatile memory, a non-volatile memory, a random access memory (RAM), or other suitable device. In a typical arrangement, memory circuitry 601C may include a non-volatile memory for long term data storage and a volatile memory that functions as system memory for processor circuitry 602C. Memory circuitry 601C may exchange data with processor circuitry 602C over a data bus. Control lines and an address bus between memory circuitry 601C and processor circuitry 602C also may be present (not shown in FIG. 11). Memory circuitry 601C is considered a non-transitory computer readable medium.

Memory circuitry 601C may be configured to store information (such as access information, onboarding information etc.) in a part of the memory.

FIG. 12 shows a block diagram of an example fourth core network node 600D, such as a core network node implementing a positioning function, such as an LMF, according to the disclosure. The fourth core network node 600D comprises memory circuitry 601D, processor circuitry 602D, and an interface 603D. The fourth core network node 600D may be configured to perform any of the methods disclosed in FIG. 4. In other words, the fourth core network node 600D may be configured for enabling a first wireless device to determine a relative position between a plurality of second wireless devices.

The interface 603D may be a wired interface for communicating with one or more core network nodes.

The fourth core network node 600D is configured to receive, for example via the interface 603D, from a service API controlling node, a request for determining a relative position of the plurality of second wireless devices, the request comprising information identifying the plurality of second wireless devices.

The fourth core network node 600D is configured to perform, for example using the processor circuitry 602D and/or the interface 603D, a positioning procedure to determine the relative position between a plurality of second wireless devices.

The fourth core network node 600D is configured to send, for example via the interface 603D, to the service API controlling node, a positioning result message comprising the relative position of the plurality of second wireless devices.

Processor circuitry 602D is optionally configured to perform any of the operations disclosed in FIG. 7 (such as any one or more of S502, S506, S508). The operations of the fourth core network node 600D may be embodied in the form of executable logic routines (for example, lines of code, software programs, etc.) that are stored on a non-transitory computer readable medium (for example, memory circuitry 601D) and are executed by processor circuitry 602D).

Furthermore, the operations of the fourth core network node 600D may be considered a method that the fourth core network node 600D is configured to carry out. Also, while the described functions and operations may be implemented in software, such functionality may also be carried out via dedicated hardware or firmware, or some combination of hardware, firmware Memory circuitry 601D may be one or more of a buffer, a flash memory, a hard drive, a removable media, a volatile memory, a non-volatile memory, a random access memory (RAM), or other suitable device. In a typical arrangement, memory circuitry 601D may include a non-volatile memory for long term data storage and a volatile memory that functions as system memory for processor circuitry 602D. Memory circuitry 601D may exchange data with processor circuitry 602D over a data bus. Control lines and an address bus between memory circuitry 601D and processor circuitry 602D also may be present (not shown in FIG. 12). Memory circuitry 601D is considered a non-transitory computer readable medium.

Memory circuitry 601D may be configured to store information (such as information identifying the plurality of second wireless devices, relative positions of the plurality of second wireless devices, etc.) in a part of the memory.

Examples of methods and products (network nodes and wireless device) according to the disclosure are set out in the following items:

Item 1. A method performed by a service Application Programming Interface, API, controlling node, for enabling a first wireless device to determine a relative position between a plurality of second wireless devices based on a positioning function of a core network, the method comprising:
receiving (S408), from the first wireless device, over an established data connection, an authorization request message for using a service API, the authorization request message comprising access information authenticating the first wireless device,
authorizing (S410), using a data management function and based on the access information, the first wireless device to use the service API for positioning of wireless devices,
receiving (S414), from the first wireless device, using the service API for positioning of wireless devices, a message comprising information identifying the plurality of second wireless devices, wherein the message requests a determination of the relative position of the plurality of second wireless devices,
authorizing (S416), using a data management function and the message comprising information identifying the plurality of second wireless devices, the first wireless device to determine the relative position of the plurality of second wireless devices,
upon the first wireless device being authorized to determine the relative position of the plurality of second wireless devices, performing (S418), based on the positioning function and the message identifying the plurality of second wireless devices, a positioning procedure for determining the relative position of the plurality of second wireless devices, and
sending (S420), to the first wireless device, using the service API for positioning of wireless devices, the relative position of the plurality of second wireless devices.

Item 2. The method according to Item 1, wherein authorizing (S404′) the first wireless device to access the service API for positioning of wireless devices comprises:
sending (S410A), to a network node implementing a data management function, an authorization validation request message comprising the authentication information to validate whether the first wireless device is authorized to access the service API for positioning of wireless devices, and
upon the first wireless device being authorized to access the service API for positioning of wireless devices, receiving (S410B), from the network node implementing a data management function, an authorization validation accept message.

Item 3. The method according to Item 1 or 2, wherein the method comprises:
transmitting (S412), to the first wireless device, using the service API for positioning of wireless devices, an authorization accept message indicating that the first wireless device has been accepted to use the service API for positioning of wireless devices.

Item 4. The method according to Item 3, wherein the authorization accept message comprises dedicated access information required to use the service API for positioning of wireless devices.

Item 5. The method according to any one of the Items 1 to 4, wherein authorizing (S416) comprises validating (S416A), with the data management function and based on the message comprising the identifier identifying the plurality of second wireless devices, whether one or more rules for accessing the relative position of the plurality of second wireless devices are fulfilled.

Item 6. The method according to Item 5, wherein the one or more rules comprises one or more of:
the relative position of the plurality of second wireless devices not being restricted,
the first wireless device belongs to a same group as the plurality of second wireless devices,
the first wireless device being specifically authorized to access the relative position of the plurality of second wireless devices.

Item 7. The method according to any one of the previous Items, wherein the access information comprises one or more of authorization information, authentication information, an address to a service API controlling node and a fully qualified domain name, FQDN, for the service API controlling node.

Item 8. The method according to any one of the previous Items, wherein performing (S418) the positioning procedure comprises:
sending (S418A), to the network node implementing the positioning function, based on the message identifying the plurality of second wireless devices, a request for determining a relative position of the plurality of second wireless devices, and
upon the first wireless device being authorized to access the relative position of the plurality of second wireless devices, receiving (S418B), from the network node implementing the positioning function of the core network, a positioning result message comprising the relative position of the plurality of second wireless devices.

Item 9. A method performed by a network node implementing a data management function, for enabling a first wireless device to determine a relative position between a plurality of second wireless devices, the method comprising:
receiving (S308′), from a service Application Programming Interface, API, controlling node, a validation request message to validate whether the first wireless device is authorized to use a service API for positioning of wireless devices, wherein the validation request message comprises access information for accessing the service API for positioning of wireless devices,
validating (S310′), based on the access information and one or more rules and/or subscription data, whether the wireless device is authorized to use the service API for positioning of wireless devices, and
upon the first wireless device being authorized to use the service API for positioning of wireless devices, transmitting (S312′), to the service API controlling node, an authorization validation accept message, wherein the authorization validation accept message comprises dedicated information required to use the service API for positioning of wireless devices.

Item 10. The method according to Item 9, wherein the method comprises:
receiving (S314) a request message to validate that the first wireless device is authorized to access the relative position of the plurality of second wireless devices, wherein the request message comprises information identifying the plurality of second devices,
validating (S316) based on the dedicated access information and the information identifying the plurality of second wireless devices, whether one or more rules for accessing the relative position of the plurality of second wireless devices are fulfilled, and
upon the first wireless device being authorized to access the relative position of the plurality of second wireless devices, sending (S318) a positioning accept message to the service API controlling node indicating that the first wireless device is authorized to access the relative position of the plurality of second wireless devices.

Item 11. The method according to Item 10, wherein the one or more rules comprises one or more of:
the relative position of the plurality of second wireless devices not being restricted,

I the first wireless device belongs to a same group as the plurality of second wireless devices,
the first wireless device being specifically authorized to access the relative position of the plurality of second wireless devices.

Item 12. The method according to any one of the Items 9 to 11, wherein the access information comprises one or more of authorization information, and authentication information, an address to a service API controlling node and a fully qualified domain name, FQDN, for the service API controlling node.

Item 13. A method performed by a first wireless device, for determining a relative position between a plurality of second wireless devices based on a positioning function of a core network, the method comprising:
sending (S109A′), to a service Application Programming Interface, API, controlling node of a core network, over an established data connection, an authorization request message to use a service API for positioning of wireless devices, the authorization request message comprising access information for authenticating the first wireless device,
upon receiving an authorization accept message to use the service API for positioning of wireless devices, sending (S110′), to the service API controlling node using the service API for positioning of wireless devices, a message identifying the plurality of second wireless devices, wherein the message requests a determination of the relative position of the plurality of second wireless devices, and
upon the first wireless device being authorized by the service API controlling node to access the relative position of the plurality of second wireless devices, receiving (S112), using the service API for positioning of wireless devices, the relative position of the plurality of second wireless devices.

Item 14. The method according to Item 13, wherein the method comprises:
upon the wireless device being authorized to use the service API, receiving (S109B′), from the service API controlling node, an authorization accept message.

Item 15. The method according to Item 13 or 14, wherein the access information comprises one or more of authorization information, authentication information, an address to a service API controlling node and a fully qualified domain name, FQDN, for the service API controlling node.

Item 16. The method according to any one of the Items 13-15, wherein the authorization accept message comprises dedicated information required to use the service API for positioning of wireless devices.

Item 17. A method performed by a network node implementing a positioning function of a core network, for enabling a first wireless device to determine a relative position between a plurality of second wireless devices, the method comprising:
receiving (S502), from a service Application Programming Interface, API, controlling node, a request for determining a relative position of the plurality of second wireless devices, the request comprising information identifying the plurality of second wireless devices,
performing (S506) a positioning procedure to determine the relative position between a plurality of second wireless devices, and
sending (S508), to the service API controlling node, a positioning result message comprising the relative position of the plurality of second wireless devices.

Item 18. A service Application Programming Interface, API, controlling node comprising memory circuitry, processor circuitry, and an interface, wherein the service API controlling node is configured to perform any of the methods according to any of Items 1-8.

Item 19. A network node implementing a data management function comprising memory circuitry, processor circuitry, and an interface, wherein the network node implementing the data management function is configured to perform any of the methods according to any of Items 9-12.

Item 20. A wireless device comprising memory circuitry, processor circuitry, and a wireless interface, wherein the wireless device is configured to perform any of the methods according to any of Items 13-16.

Item 21. A network node implementing a positioning function of a core network comprising memory circuitry, processor circuitry, and an interface, wherein the network node implementing the positioning function is configured to perform any of the methods according to Item 17.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1 to 12 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware. The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.
Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method performed by a service Application Programming Interface (API), controlling node, for enabling a first wireless device to determine a relative position between a plurality of second wireless devices based on a positioning function of a core network, the method comprising:
receiving, from the first wireless device, over an established data connection, an authorization request message for using a service API, the authorization request message comprising access information authenticating the first wireless device,
authorizing, using a data management function and based on the access information, the first wireless device to use the service API for positioning of wireless devices,
receiving, from the first wireless device, using the service API for positioning of wireless devices, a message comprising information identifying the plurality of second wireless devices, wherein the message requests a determination of the relative position of the plurality of second wireless devices,
authorizing, using a data management function and the message comprising information identifying the plurality of second wireless devices, the first wireless device to determine the relative position of the plurality of second wireless devices,
upon the first wireless device being authorized to determine the relative position of the plurality of second wireless devices, performing, based on the positioning function and the message identifying the plurality of second wireless devices, a positioning procedure for determining the relative position of the plurality of second wireless devices, and
sending, to the first wireless device, using the service API for positioning of wireless devices, the relative position of the plurality of second wireless devices.

2. The method according to claim 1, wherein authorizing the first wireless device to access the service API for positioning of wireless devices comprises:
sending, to a network node implementing a data management function, an authorization validation request message comprising the authentication information to validate whether the first wireless device is authorized to access the service API for positioning of wireless devices, and
upon the first wireless device being authorized to access the service API for positioning of wireless devices, receiving, from the network node implementing a data management function, an authorization validation accept message.

3. The method according to claim 1, wherein the method comprises:
transmitting, to the first wireless device, using the service API for positioning of wireless devices, an authorization accept message indicating that the first wireless device has been accepted to use the service API for positioning of wireless devices.

4. The method according to claim 3, wherein the authorization accept message comprises dedicated access information required to use the service API for positioning of wireless devices.

5. The method according to claim 1, wherein authorizing comprises validating, with the data management function and based on the message comprising the identifier identifying the plurality of second wireless devices, whether one or more rules for accessing the relative position of the plurality of second wireless devices are fulfilled.

6. The method according to claim 4, wherein the one or more rules comprises one or more of:
the relative position of the plurality of second wireless devices not being restricted,
the first wireless device belongs to a same group as the plurality of second wireless devices,
the first wireless device being specifically authorized to access the relative position of the plurality of second wireless devices.

7. The method according to claim 1, wherein the access information comprises one or more of authorization information, authentication information, an address to a service API controlling node and a fully qualified domain name (FQDN) for the service API controlling node.

8. The method according to claim 1, wherein performing the positioning procedure comprises:
sending, to the network node implementing the positioning function, based on the message identifying the plurality of second wireless devices, a request for determining a relative position of the plurality of second wireless devices, and
upon the first wireless device being authorized to access the relative position of the plurality of second wireless devices, receiving, from the network node implementing the positioning function of the core network, a positioning result message comprising the relative position of the plurality of second wireless devices.

9. A method performed by a network node implementing a data management function, for enabling a first wireless device to determine a relative position between a plurality of second wireless devices, the method comprising:
receiving, from a service Application Programming Interface (API) controlling node, a validation request message to validate whether the first wireless device is authorized to use a service API for positioning of wireless devices, wherein the validation request message comprises access information for accessing the service API for positioning of wireless devices,
validating, based on the access information and one or more rules and/or subscription data, whether the wireless device is authorized to use the service API for positioning of wireless devices, and
upon the first wireless device being authorized to use the service API for positioning of wireless devices, transmitting, to the service API controlling node, an authorization validation accept message, wherein the authorization validation accept message comprises dedicated information required to use the service API for positioning of wireless devices.

10. The method according to claim 9, wherein the method comprises:
receiving a request message to validate that the first wireless device is authorized to access the relative position of the plurality of second wireless devices, wherein the request message comprises information identifying the plurality of second devices,
validating based on the dedicated access information and the information identifying the plurality of second wireless devices, whether one or more rules for accessing the relative position of the plurality of second wireless devices are fulfilled, and
upon the first wireless device being authorized to access the relative position of the plurality of second wireless devices, sending a positioning accept message to the service API controlling node indicating that the first wireless device is authorized to access the relative position of the plurality of second wireless devices.

11. The method according to claim 10, wherein the one or more rules comprises one or more of:
the relative position of the plurality of second wireless devices not being restricted,
the first wireless device belongs to a same group as the plurality of second wireless devices,
the first wireless device being specifically authorized to access the relative position of the plurality of second wireless devices.

12. The method according to claim 9, wherein the access information comprises one or more of authorization information, and authentication information, an address to a service API controlling node and a fully qualified domain name (FQDN) for the service API controlling node.

13. A method performed by a first wireless device, for determining a relative position between a plurality of second wireless devices based on a positioning function of a core network, the method comprising:
sending, to a service Application Programming Interface (API) controlling node of a core network, over an established data connection, an authorization request message to use a service API for positioning of wireless devices, the authorization request message comprising access information for authenticating the first wireless device,
upon receiving an authorization accept message to use the service API for positioning of wireless devices, sending, to the service API controlling node using the service API for positioning of wireless devices, a message identifying the plurality of second wireless devices, wherein the message requests a determination of the relative position of the plurality of second wireless devices, and
upon the first wireless device being authorized by the service API controlling node to access the relative position of the plurality of second wireless devices, receiving, using the service API for positioning of wireless devices, the relative position of the plurality of second wireless devices.

14. The method according to claim 13, wherein the method comprises:
upon the wireless device being authorized to use the service API, receiving, from the service API controlling node, an authorization accept message.

15. The method according to claim 13, wherein the access information comprises one or more of authorization information, authentication information, an address to a service API controlling node and a fully qualified domain name, FQDN, for the service API controlling node.

16. The method according to claim 13, wherein the authorization accept message comprises dedicated information required to use the service API for positioning of wireless devices.

17. (canceled)

18. A service Application Programming Interface (API) controlling node comprising memory circuitry, processor circuitry, and an interface, wherein the service API controlling node is configured to perform the method of claim 1.

19. A network node implementing a data management function comprising memory circuitry, processor circuitry, and an interface, wherein the network node implementing the data management function is configured to perform the method of claim 9.

20. A wireless device comprising memory circuitry, processor circuitry, and a wireless interface, wherein the wireless device is configured to perform the method of claim 13.

21. (canceled)
